(19) United States
(12) Patent Application Publication
(10) Pub. No.: US 2013/0159061 A1
(43) Pub. Date: Jun. 20, 2013

(54) DISPLAYING AND CHANGING SCENARIO-BASED OR PROCESS-BASED BUSINESS CONFIGURATIONS

(71) Applicants: Joachim Fessler, Grafenberg (DE); Holger Knospe, Wiesloch (DE); Ulrich Keil, Heidelberg (DE); Marianne Brosche, Heidelberg (DE); Jochen Mayerle, Flein (DE)

(72) Inventors: Joachim Fessler, Grafenberg (DE); Holger Knospe, Wiesloch (DE); Ulrich Keil, Heidelberg (DE); Marianne Brosche, Heidelberg (DE); Jochen Mayerle, Flein (DE)

(21) Appl. No.: 13/326,026

(22) Filed: Dec. 14, 2011

(51) Int. Cl. G06Q 10/06

(52) U.S. Cl. 705/7.36

(57) ABSTRACT

A user interface can concurrently display a work frame including business configuration user interface elements relating to a selected business process feature of a business scenario and a navigation frame including first user interface elements arranged within the navigation frame to represent at least some of a plurality of business process features of the business scenario. The business scenario can be part of a business configuration of a business software architecture used by an organization. A user input relating to a change to the business configuration can be received via the business configuration user interface elements, and a business configuration model storing the business configuration can be updated to reflect the received change.

### CROSS-REFERENCE TO RELATED APPLICATIONS

The current application is related to the following co-pending and co-owned U.S. patent applications, the disclosure of each of which is incorporated herein in its entirety: [[Attorney docket nos. 34874-774F01US/2011P00201US, 34874-760F01US/2011P00149US, 34874-761F01US/2011P00163US, 34874-763F01US/2011P00166US, 34874-765F01US/2011P00168US, 34874-766F01US/2011P00169US, 34874-768F01US/2011P00171US, 34874-769F01US/2011P00172US, 34874-770F01US/2011P00173US, 34874-771F01US/2011P00174US, 34874-772F01US/2011P00175US, 34874-773F01US/2011P00198US, and 34874-781F01US/2011P00363US]].

### TECHNICAL FIELD

The subject matter described herein relates generally to enhancing user interaction with, and navigation among, features, functions, controls, and the like of an integrated software suite, such as for example an enterprise resource planning solution.

### BACKGROUND

The inherent complexity of business processes and their implementation in business software solutions, enterprise resource planning (ERP) systems, and the like can present substantial challenges to users and can be a serious obstacle to widespread operative use of process models in the software landscape. A wealth of highly technical process modeling notations (e.g. business process modeling notation (BPMN) editors and process engines, enhanced process chains (EPC), modeling hierarchies built on these or similar model types, etc.) is currently available for use in in technical systems. However, these types of resources are typically difficult for a non-technical user to understand and use. While numerous non-technical tools exist for depicting high-level processes or scenarios (e.g. drawing, mind-map, or presentation tools, or the like), such tools typically lack any operative connection with the underlying transactional data relating to specific instances of business processes in a business software architecture and therefore can provide only a picture of an idealized concept of a business process or scenario.

Typical, day-to-day business users do not know and do not generally wish to learn the syntax of BPMN or similar notations just to be able to match their business needs with the features and capabilities of a business software solution. Notations like BPMN or EPC are generally addressed to a more technical audience and can be seen as powerful graphical programming languages that by their very nature are detail rich. For process or scenario modelers, it can be difficult to simplify a business scenario model to a suitable abstraction level and to include only a necessary level of information. In real world organizations, business users have specific roles within the organization, i.e. they work as accountants, project managers, sales representatives etc. Therefore, business processes navigation and visualization tools are advantageously relevant for a specific target role. The business scenario model of an organization can be integrated by nature. For example, sales processes can trigger fulfilling, and fulfilling can trigger accounting. Business users can have a need to understand, discuss, and adapt the transition points between end-to-end scenario and process chains in the software.

### SUMMARY

In one aspect, a method includes accessing a definition of a business scenario that includes a designation of a plurality of business process features required for completion of the business scenario, one or more feature modules of an business software architecture that provide functionality relating to one or more of the plurality of business process features, and an order in which the plurality of business process features are to be executed. A work frame and a navigation frame are displayed concurrently via a user interface presentable on a computer display device. The navigation frame includes a first plurality of user interface elements arranged to represent at least some of the plurality of business process features, and the work frame includes a plurality of business configuration user interface elements relating to a selected one of the plurality of business process features. A user input relating to a change to a business configuration for an organization using the business software architecture is received via one or more of the plurality of business configuration user interface elements, the user input, and a business configuration model storing the business configuration is updated to reflect the received change.

In some variations one or more of the following features can optionally be included in any feasible combination. The change can optionally include an update to at least one of master data relating to the selected business process feature, a role assignment relating to the selected business process feature, and a functional detail relating to the selected business process feature. The update can optionally include at least one of an addition, a deletion, and a modification. The business configuration user interface elements can optionally include at least one of master data entry fields, organizational chart user interface elements, and functional detail user interface elements. The business configuration model and the business process definition can optionally be stored in at least one repository. The business configuration can optionally include organization-specific versions of the business scenario and at least one other business scenario.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Implementations of the current subject matter can provide one or more advantages. For example, process-based customization of a business configuration can be provided via a visual tool based on a graphical display of a specific business process. This approach can provide an intuitive and convenient user interface for changing configuration settings without requiring a user making the changes to know the exact location in the complex functional tree of the business configuration catalog. By stepping through a business process assisted by a process navigation tool, an administrator can readily navigate to important local setting options that can be modified in the specific business process from within one graphical process view. In further implementations, an organizational view and a process-based view can be combined to allow an administrator to view and edit employee assignments to a corresponding process or process step.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a screenshot of a user interface illustrating a scenario landscape overview view;

FIG. 2 shows another screenshot of a user interface illustrating a linear single business process view and associated user interface features for guided modification of aspects of a business process;

FIG. 3 shows another screenshot of a user interface illustrating a linear single business process view and associated user interface features for guided pairing of organizational roles with aspects of a business process;

FIG. 4 is a process flow diagram illustrating aspects of a method having one or more features consistent with implementations of the current subject matter;

FIG. 5 is a diagram illustrating aspects of a system showing features consistent with implementations of the current subject matter;

FIG. 6 is a diagram illustrating aspects of a system showing features consistent with implementations of the current subject matter; and

FIG. 7 is a diagram illustrating a data repository showing features consistent with implementations of the current subject matter.

When practical, similar reference numbers denote similar structures, features, or elements.

### DETAILED DESCRIPTION

Using currently available tools, the process of customizing the business configuration of a business software architecture, such as for example an enterprise resource planning (ERP) system typically relies on a functional or wizard-based approach. Such tools typically do not support business process or business scenario based views on the current business configuration of the business software architecture for a given organization (e.g. a company, corporation, partnership, department, division, etc.).

A scenario landscape for an organization can refer to a set including all or some of the business scenarios and/or business processes characterizing an organization's operations. In general a business scenario can includes one or more business processes, process steps, or other business process features. Business process features can include, but are not limited to, one or more of business processes, process steps, sub-processes, tasks, activities, and the like. The business scenarios and business processes can be managed, and tasks relating to the completion of one or more steps of the business processes can be supported by, one or more feature modules of a business software architecture, such as for example an enterprise resource planning (ERP) system. The terms “instance of a business process,” “instance of a business scenario,” and similar descriptive terminology is intended to refer to a specific execution of a business process or a business scenario, respectively. For example, for a business scenario relating to sale of a product, each order taken and filled for that product can be considered as an instance of the business scenario. A business configuration can be a set of business scenarios including sets of business processes or business process features supported by the business software architecture and optionally customized to reflect the actual, real-life business functions (e.g. end-to-end business processes) performed by employees or other organization members on a recurring basis. A business configuration for an organization customer of a business software architecture is usually set up upon initial installation with occasional modifications or updates provided to reflect changes to the underlying real-life processes and procedures. Such a business configuration is typically constructed like a catalog, and its functions can be structured according to business areas, packages, topics and options. Once the initial business configuration is set up, all decisions are made, and the scoping is done, the business software architecture is ready for productive usage.

Changing a specific setting (e.g. modifying the behavior of a feature or function, adding or deleting functions or features, etc.) after the initial business configuration is established can be challenging due to the need to locate a specific setting in the business configuration catalog that corresponds to one or more specific business processes or other business process features of a business scenario. Unless a user is technically proficient in complicated business process or business scenario representation tools and able to map knowledge gleaned from a typically static representation to a catalog view of available functions and features in the current business configuration and/or in a global system landscape that includes all available functions and features both of the core software platform of the business software architecture and of external service providers (e.g. third party systems and/or applications) to know where to search, he or she may be required to navigate through a large amount or even all of the business configuration to find a relevant setting or selection that will impact the business scenario as it is experienced by an end-user.

A further failing of many currently available solutions is the general lack of an overview concurrently displaying relationships between an organization's organizational chart and a business process-centric or business scenario-centric view. Displaying and/or enabling modifications to role and task assignments relating to an organization-specific business scenario or set of business scenarios or business processes by an administrator-level user can also be useful, but is currently not possible with existing solutions.

To address these and potentially other issues with currently available solutions, methods, systems, articles of manufacture, and the like consistent with one or more implementations of the current subject matter can, among other possible advantages, provide a process-based view on the business configuration of a business software architecture accessible to members of an organization, which can, optionally in conjunction with access to scenario-controlling attributes of master data, provide a business user with the ability to change and adapt business configuration and master data attribute settings easily and with the full scenario context at hand. Through convenient and intuitive visualizations of business scenarios, business processes, and other business process features that are integrated in the system and supported by a unified meta-model, a user can readily navigate to a screen that enables alteration, initiation, deletion, etc. of a control setting corresponding to one or more task screens, function modules, etc. of the business software architecture that are required for at least partial completion of a process step or sub-process. In one example, a user can right-click in a scenario navigation view of a business scenario or otherwise activate a business configuration modification screen or user interface pane relating to a selected business process or other business process feature. Alternatively or in addition, some other user interface interaction (e.g. a keyboard input, a selection of a specific user interface elements, a voice command, a combination or these or others, or the like) can activate this functionality. Another screen or pane can be activated in a similar manner to provide for entry, deletion, modification, etc. of master data.

Using one or more implementations of the current subject matter, a user need not navigate through an entire business configuration to identify a necessary user interface screen or element to make a change to the business configuration. Mapping information between business scenarios, business processes, business process features related thereto, or other aspects of a business software architecture and a specific configuration setting corresponding to these aspects of the business software architecture can be stored in a business scenario meta-model. The business scenario meta-model can provide mapping information between a business software architecture aspect and a corresponding location in the business configuration. An additional benefit can be realized in that changes made to the settings of the business configuration can be immediately (or at least rapidly) be reflected in the corresponding view of a business scenario for all users of the business software architecture.

A scenario landscape map such as is described herein can serve as an integrated part of a business software solution and can include one or more of the following capabilities. In some implementations, a scenario landscape map can provide a visualization of business scenarios using a transit-map style, for example using a visual analog to a geographical map in the form of a schematic diagram in which routes and stations of a public transport system represent process flow and actions that are performed in the execution of a business process or scenario. The scenario landscape map can translate scenario flows visualized as route lines into end-to-end business scenarios, and stations or stops visualized as labeled icons into business processes and other business process features. A business user or prospective business user can thereby be assisted in efficiently understanding, discussing, and/or adjusting the underlying business scenario model of a business software solution in either or both of the software sales and software implementation cycles. Unlike more technical displays of business process information (e.g. business process modeling notation of the like), the scenario landscape map deliberately uses a pre-calculated level of reduced detail and accuracy in representing business scenario model semantics. Instead, the scenario landscape map, which can also be referred to as a scenario browser or the like, makes use of straight lines, fixed angles, and/or other relatively simply geometric shapes, and can make use of an approximately similar, fixed distance between “stops” on the route line (each of which can represent a business process or other business process feature) while hiding actual complications (e.g. decision trees, loops, branches, alternative routes, etc.) of the “real” underlying business process flow and, optionally, end-to-end scenario dependencies as well. Such an approach can create a simplified, linear abstracted visualization of the underlying software reality that provides just the right degree of detail for business-focused discussions.

Continuing with the analogy to transit maps, non-relevant or less relevant aspects of reality (e.g. pedestrian routes, buildings, rivers, etc.) can be excluded from the visualization to provide only the key information necessary to assist a rider in getting from a starting location to a destination. In a visualization model consistent with implementations of the current subject matter, “stations” (e.g. business processes or other business process features represented visually as points along the route line) that serve as interchanges between lines can be thought of as analogous to one or more integration or intersection points between end-to-end business scenarios.

The scenario landscape map or scenario browser need not be static, “birds eye” view of a business scenario landscape, but can instead serve to focus information that are most relevant to a currently active business scenario, for example by positioning a route line representing the currently active business process in the approximate center of a scenario landscape map view with other integrated or intersecting business scenarios that form part of the business scenario landscape displayed in relation to the currently active business scenario. In another example, a most relevant business scenario of a specific role can be positioned in this manner with the most relevant business scenario being represented as a route line in the approximate center of the scenario landscape map view.

A scenario landscape map or scenario browser can also enable seamless zoom-in and zoom-out across an entire business scenario model of the organization in a manner similar to electronic geographical maps. A single navigation tool, for example one as described in one or more of the related applications listed above or as described below can also be launched via the scenario landscape map or scenario browser to allow switching from a scenario landscape view to a transactional data processing mode.

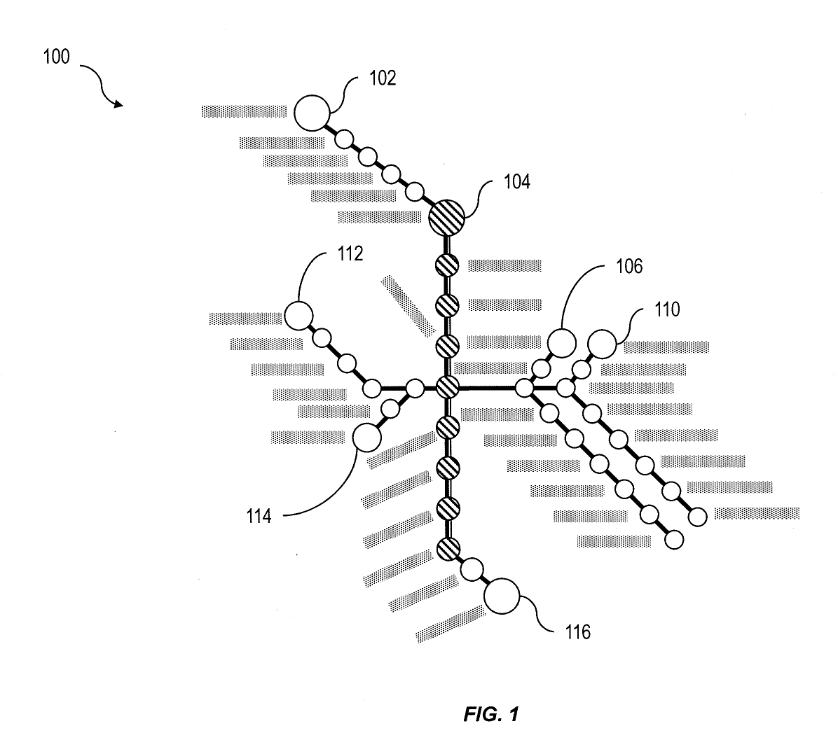

FIG. 1 illustrates an example of a scenario landscape overview map or scenario browser 100, which includes relational links between a plurality of business scenarios in a scenario landscape. Each of several business scenarios 102, 104, 106, 110, 112, 114, 116 are shown at a linear overview degree of detail to depict the relations between the different business scenarios 102, 104, 106, 110, 112, 114, 116 in the scenario landscape. In an implementation, the overview map can be modeled as a transit map that shows the place and the function of each business scenario in the scenario landscape as a whole. Intrinsic relation types between the business scenarios 102, 104, 106, 110, 112, 114, 116 can include, but are not limited to, a predecessor scenario, which is defined as a business scenario whose completion is a prerequisite to another business scenario (e.g. business scenario 102, which includes several process steps (shown in FIG. 1 as smaller circles) that lead to the initiation of business scenario 104); a successor scenario, which is defined as a business process having a predecessor process (e.g. business scenario 104, which has business scenario 102 as its predecessor scenario); a joint use scenario, which is defined as a business scenario that shares a common sub-scenario, a common business process or business process feature, a common data object, a common responsible entity (e.g. a person, a unit, etc.), a common event, or the like (e.g. business scenarios 106 and 110, which share business processes or other business process features with business scenario 112; or business scenario 116 and business scenario 104, which share a business process); and a hierarchical use scenario, which is defined as a business scenario that uses another business scenario as a sub-scenario (e.g. business scenario 112, which includes as a branching sub-scenario the business scenario 114). Also as shown in FIG. 1, the business scenario and/or the included business processes or other business process features can be labeled in a manner similar to stops on a transit map.

The scenario landscape overview map 100 can advantageously be arranged in a process-centric manner, for example such that a selected business scenario 104 is arranged approximately centrally in the overview diagram with other business scenarios (e.g. including but not limited to the business scenario relationships explained in the preceding paragraph) relating to the selected business scenario 104 shown branching or intersecting with the selected business scenario 104. The selected business scenario 104 can optionally be a business scenario that is most relevant to a current role of a user, a currently active business scenario, or the like. The scenario overview map 100 can also advantageously include one or more visual cues to indicate information about the various business scenarios and/or the business processes or business process features shown in the scenario overview map 100. For example, the route line 120 of the selected business process 104 can be shown in a different thickness, with a different pattern, in a different color or brightness, or the like, and the business processes and/or business process features of the selected business scenario 104 can likewise be shown with a different pattern, color, brightness, etc. Clicking on a business process or other business process feature of the selected business scenario 104 can directly navigate a user to a linear single scenario view of the currently active business scenario displayed simultaneously with a work space including user interface elements related to completion, monitoring, etc. of the selected business process or other business process feature. Clicking on a business process or business process feature of another scenario besides the selected business process 104 can cause the process overview map 100 to rearrange to show the scenario landscape with a new scenario-centric view based on the newly selected business scenario.

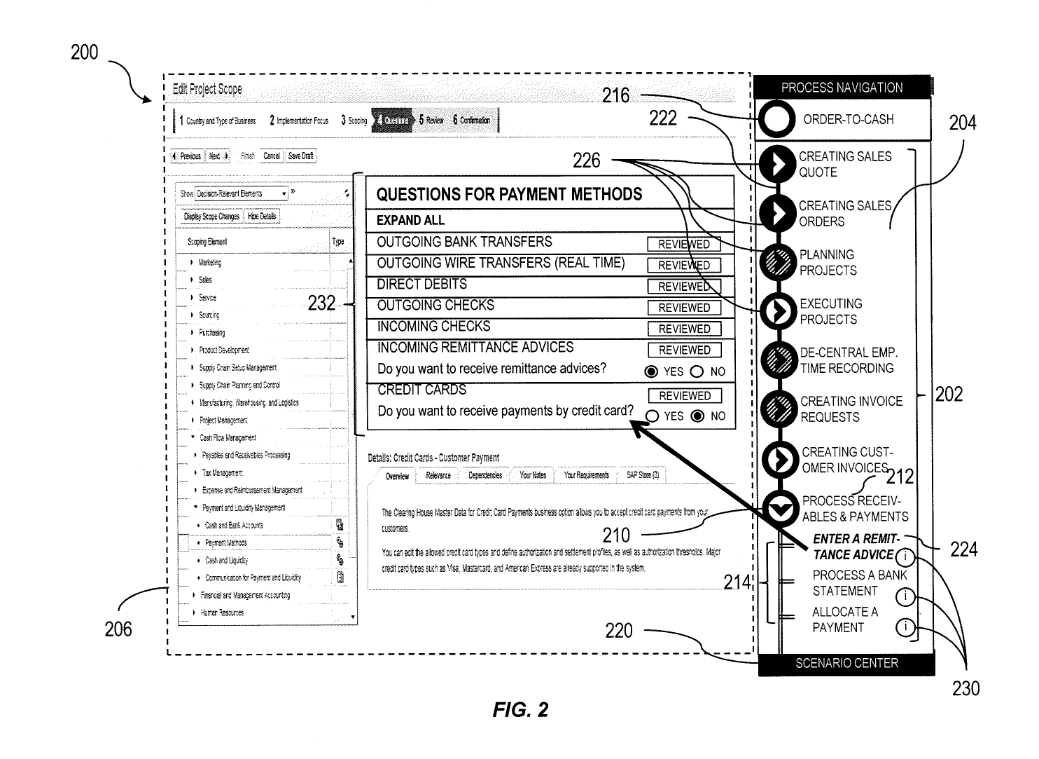

FIG. 2 illustrates an example of a linear single process view 200, which shows a single business process represented by a plurality of first user interface elements 202 in a navigation pane 204. The plurality of first user interface elements 202 are arranged to represent the business scenario as a linear sequence of business processes and/or other business process features, which can in turn each include additional business process features, etc. The structure of the business scenario is condensed into a linear view, even though the actual flow of tasks and other actions necessary to complete an instance of the business scenario often involves explicit parallelism, decisions, loops, event driven changes in control flow, exceptions, and the like. Consistent with the scope of the current subject matter, any viable approach can be used to shape a business scenario into such a linear view.

As shown in FIG. 2, a navigation pane 204 and a work pane 206 are concurrently displayed. One or more user interface elements of the plurality of first user interface elements 210 corresponding to a business process 212 having additional business process features can be expanded as shown in FIG. 2 to display additional user interface elements 214 corresponding to the business process features. Also as shown in FIG. 2, the currently active business scenario can be identified by one or more scenario identifier user elements 216. A scenario browser or scenario center, etc. user interface element 220 can link to the upper level scenario landscape overview map 100 to display an overall scenario landscape map showing intersections between scenarios and providing links to navigate to the other scenarios in the scenario landscape.

The first user interface elements 202 can optionally be displayed in a manner similar to a transit route map with each process step or sub-step being represented like a stop on the route. In this manner, a familiar visual format can rapidly convey additional information about a current context within a specific instance of the business scenario as well as status information about the various business process features along the “route” to completion of the instance. For example, a route line 222 connecting the “stops” can be presented with a first visual effect (e.g. color, brightness, shade, dots or dashes, etc.) up to the “stop” representing the business process feature that is currently “active” with related functionality being provided in the work pane 206. The currently active business process feature can be further indicated using textual or visual cues, such as for example color, shading, font, a highlighting box, etc. As a non-limiting example, the name of the business process feature displayed in conjunction with the user interface element 224 corresponding to the currently active business process feature in FIG. 2 is formatted in a bold and italicized font. A different second visual effect can be used for the part of the route line 222 leading to the “stops” past the currently active business process feature. The icons 226 used to represent the “stops” in the navigation pane can also include visual cues to inform a user about status, other business process features that are included within the currently displayed business process or business process feature user interface elements and that can be revealed by a user action to expand the route map, or the like.

Additional first user interface elements 230 (e.g. the encircled “i” icons shown in FIG. 2) can provide additional details about one or more of the process steps. For example, selection by user of one of these additional user interface elements 230 can cause the work pane 206 to display a set of business configuration user interface elements 232 via which a change in one or more functional details relating to the selected business process feature can be made. Such functional details can include functions, features, etc. provided by the underlying business software architecture and/or by external service provider software (e.g. third-party programs, external software components, modules, etc. providing functionality that is integrated within the business software architecture). In the example shown in FIG. 2, selection of the additional first user interface elements 230 corresponding to the process step of “enter a remittance advice” links in the work pane 206 to a screen displaying payment method options with second user interface elements 232 that allow activation or deactivation of various functionality relating to the selected business process or business process feature.

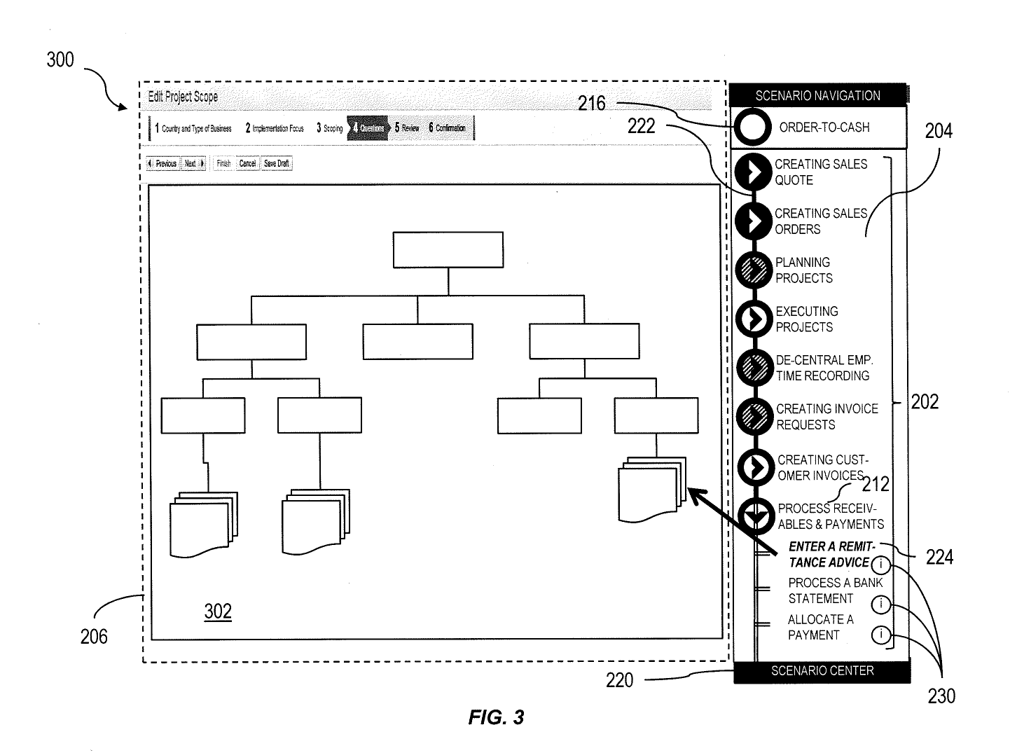

In a further implementation, an example of which is illustrated by the screenshot 300 of FIG. 3, a set of business configuration user interface elements that include organizational chart user interface elements 302 can be displayed in the work pane 206 concurrently with the navigation view in the navigation pane 204. In this manner, a business user can easily determine and/or remedy those business processes and/or business process features that do not currently have a valid assignment to at least one employee, member, etc. of the organization. Conversely, it can be equally easy to identify whether every employee, member, etc. or role of the organization company is allocated to at least one business process or business process feature. Reassignments of roles, tasks, etc. among the members of an organization can be performed visually, for example using a drag and drop functionality via which a first user interface element corresponding to a business process or business process feature displayed in the navigation pane 204 is dragged onto an organizational chart user interface element 302 in the work. The converse can also occur, in which an organizational chart user interface element 302 from the work pane 206 is dragged onto a first user interface element 202 in the navigation pane 204 to make a linkage between task and person or role or department, etc.

Change to the underlying business configuration that are made using one of the user interface views described herein, or for example those shown in FIG. 2 or FIG. 3 can be added to a business scenario model or business configuration meta-model and thereby reflected for some or all users of the business configuration. In a further implementation not shown in the drawings, the business configuration user interface elements displayed in the work pane 206 can include master data entry fields corresponding to a selected business process or other business process feature. A master data repository can be linked to receive the changes entered via these fields so that they can be reflected for users of the business software architecture.

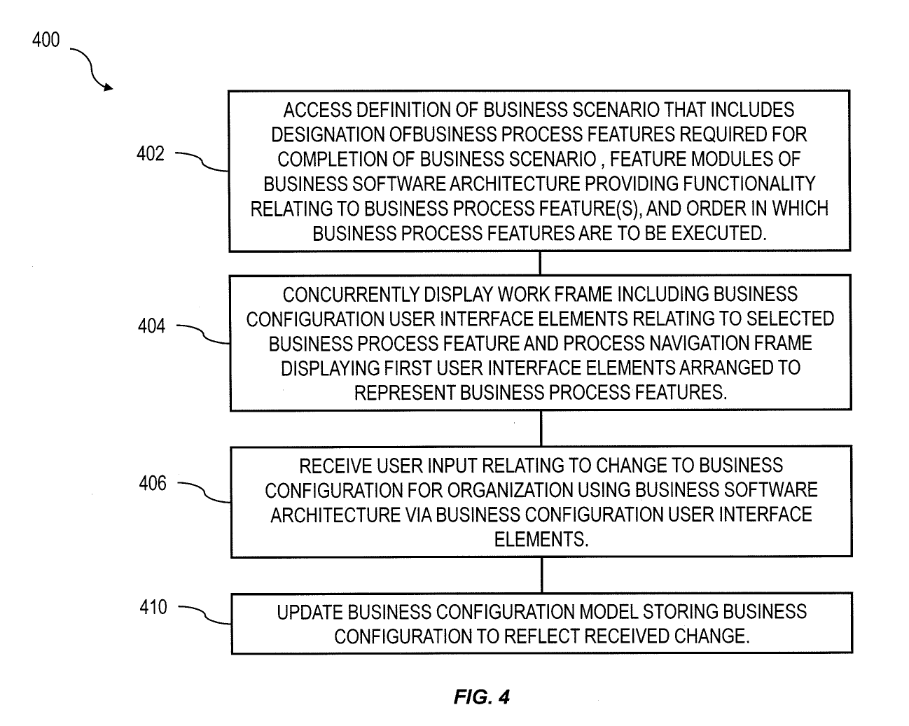

FIG. 4 shows a process flow chart 400 illustrating a method having one or more features consistent with implementations of the current subject matter. At 402, a definition of a business scenario is accessed. The definition includes a designation of a plurality of business process features required for completion of the business scenario, one or more feature modules of an business software architecture providing functionality relating to one or more of the plurality of business process features, and an order in which the plurality of business process features are to be executed. A work frame and a navigation frame are concurrently displayed at 404 via a user interface presentable on a computer display device. The navigation frame includes a first plurality of user interface elements arranged within the navigation frame to represent at least some of the plurality of business process features, while the work frame displays a plurality of business configuration user interface elements relating to a selected one of the plurality of business process features. A user input relating to a change to a business configuration for an organization using the business software architecture is received at 406 via one or more of the plurality of business configuration user interface elements, and at 410 a business configuration model storing the business configuration is updated to reflect the received change. The business configuration can include organization-specific versions of the business scenario and other business scenarios. The change can include one or more of an update to master data relating to the selected business process feature, a role assignment relating to the selected business process feature, and a functional detail relating to the selected business process feature.

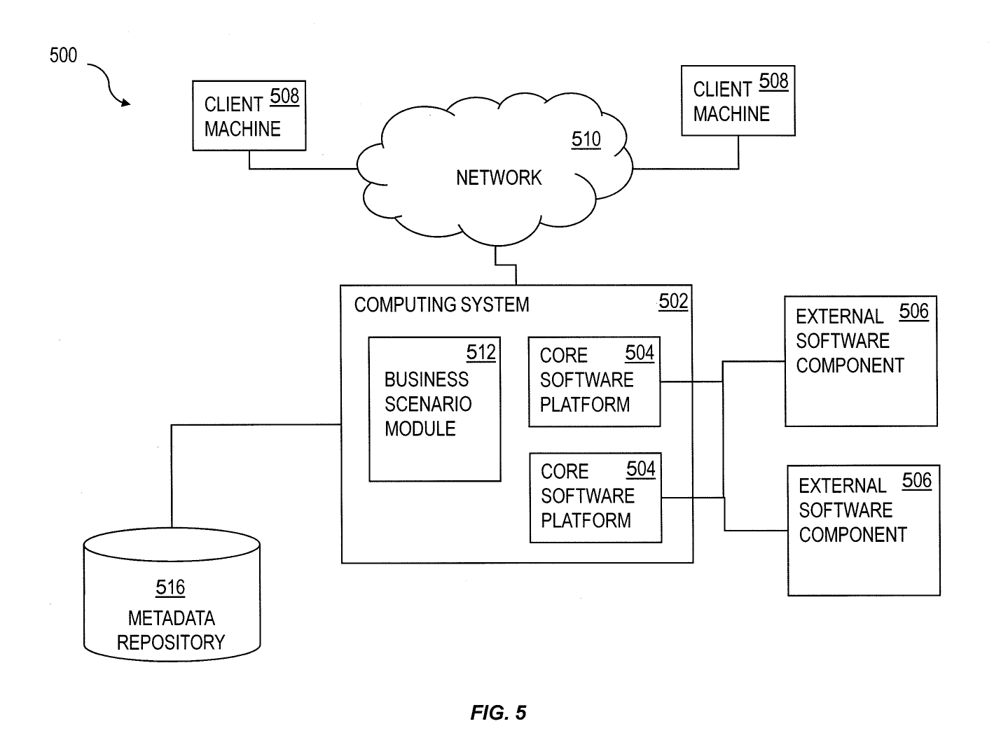

The core software platform of an ERP or other business software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. FIG. 5 shows a diagram of a system consistent with such an implementation. A computing system 502 can include one or more core software platform modules 504 providing one or more features of the ERP system. The computing system can also aggregate or otherwise provide a gateway via which users can access functionality provided by one or more external software components 506, which can be optionally be provided by one or more service providers external to the one or more core software platform modules 504. Client machines 508 can access the computing system, either via a direct connection, a local terminal, or over a network 510 (e.g. a local area network, a wide area network, a wireless network, the Internet, or the like). A business scenario guidance and recording module 512 can be hosted on the computing system 502 or alternatively, on an external system accessible over a network connection. The business scenario guidance and recording module 512 can optionally include one or more discrete software and/or hardware modules that perform operations such as those described herein.

The business scenario guidance and recording module 512 can access one or more metadata repositories 516 and/or other data repositories that can store the definition of business processes and business configuration as well as data, metadata, master data, etc. relating to definitions of the business processes, the business configuration, and/or concrete instances of the data objects (e.g. business objects) that are relevant to a specific instance of the business process. In some examples, the definition can optionally be stored as a business object. In some implementations, the business object can include a template definition of a standard business process. The template definition that can optionally be modified via one or more extensions that are stored in the one or more metadata repositories 516.

Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

In a software delivery configuration in which services of an ERP system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

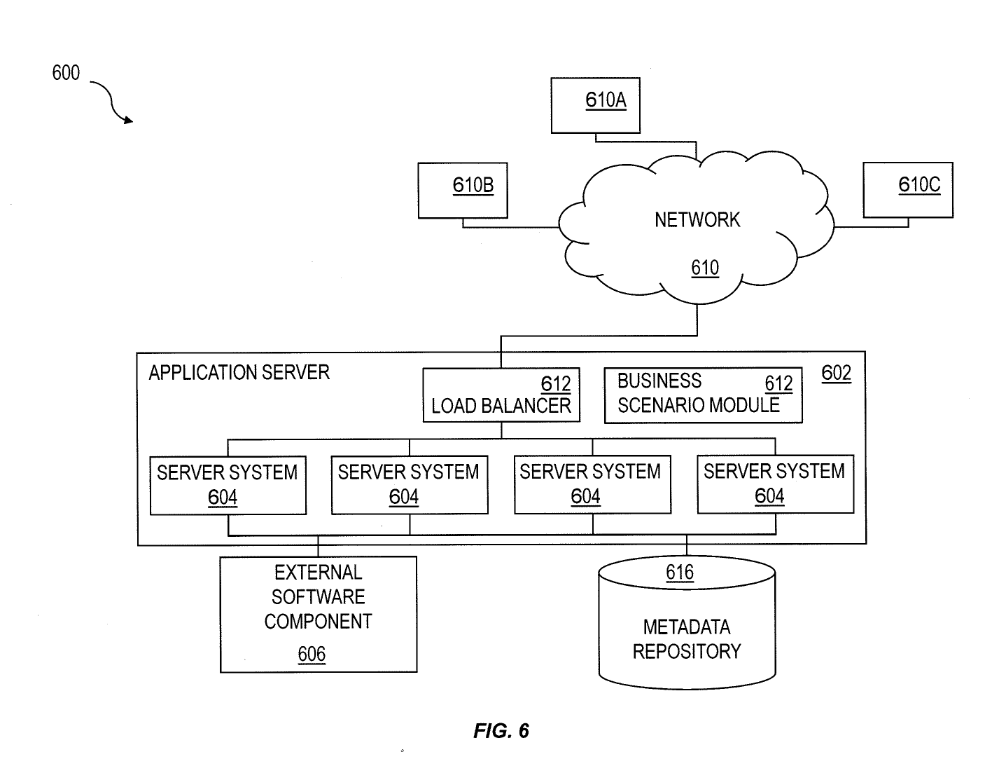

FIG. 6 shows a block diagram of a multi-tenant implementation of a software delivery architecture 600 that includes an application server 602, which can in some implementations include multiple server systems 604 that are accessible over a network 510 from client machines operated by users at each of multiple organizations 610A-610C (referred to herein as “tenants” of a multi-tenant system) supported by a single software delivery architecture 600. For a system in which the application server 602 includes multiple server systems 604, the application server can include a load balancer 612 to distribute requests and actions from users at the one or more organizations 610A-610C to the one or more server systems 604. Instances of the core software platform 504 (not shown in FIG. 6) can be executed in a distributed manner across the server systems 604. A user can access the software delivery architecture across the network using a thin client, such as for example a web browser or the like, or other portal software running on a client machine. The application server 602 can access data and data objects stored in one or more data repositories 516. The application server 602 can also serve as a middleware component via which access is provided to one or more external software components 506 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 602 that includes multiple server systems 604 that handle processing loads distributed by a load balancer 612. Potential benefits from such an arrangement can include, but are not limited to, high and reliably continuous application server availability and minimization of unplanned downtime, phased updating of the multiple server systems 604 to permit continuous availability (one server system 604 can be taken offline while the other systems continue to provide services via the load balancer 612), scalability via addition or removal of a server system 604 that is accessed via the load balancer 612, and de-coupled lifecycle processes (such as for example system maintenance, software upgrades, etc.) that enable updating of the core software independently of tenant-specific customizations implemented by individual tenants.

As in the example illustrated in FIG. 5, the metadata repository 516 can store a business object that represents a template definition of a standard business process. Each individual tenant 610A-610C can customize that standard template according to the individual business process features specific to business of the organization to which that tenant is assigned. Customizations can be stored as extensions in the metadata repository.

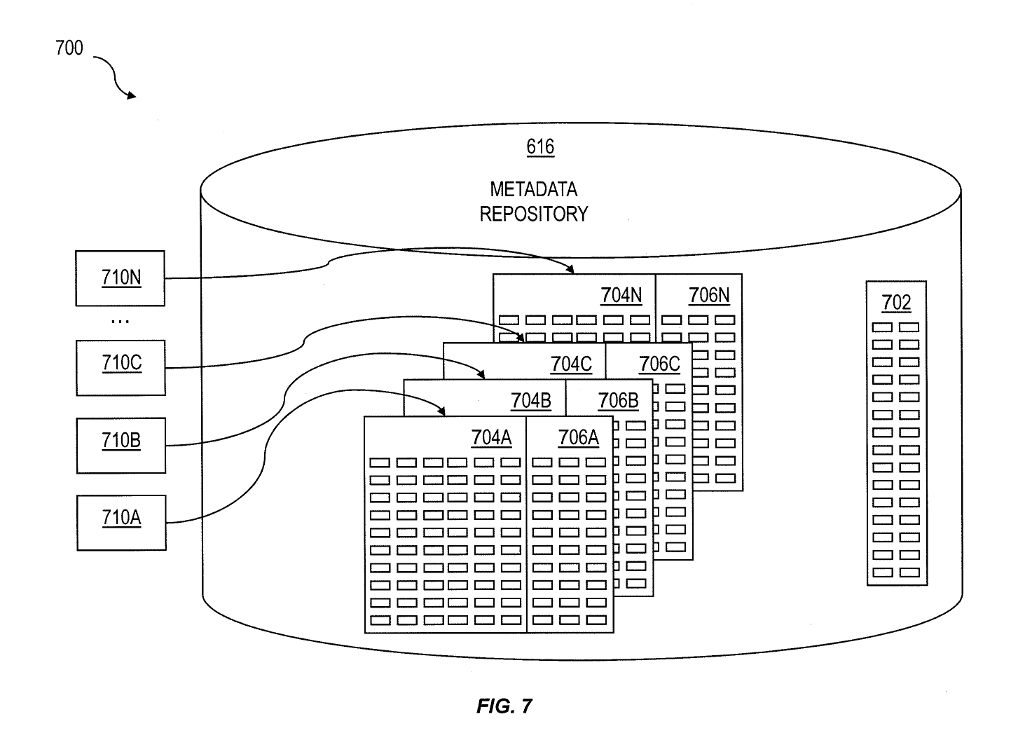

To provide for customization of the business process for each of multiple organizations supported by a single software delivery architecture 600, the data and data objects stored in the metadata repository 516 and/or other data repositories that are accessed by the application server 602 can include three types of content as shown in FIG. 7: core software platform content 702 (e.g. a standard definition of a business process), system content 704, and tenant content 706. Core software platform content 702 includes content that represents core functionality and is not modifiable by a tenant. System content 704 can in some examples be created by the runtime of the core software platform and can include core data objects that store concrete data associated with specific instances of a given business process and that are modifiable with data provided by each tenant. The data retained in these data objects are tenant-specific: for example, each tenant 610A-610N can store information about its own inventory, sales order, etc. Tenant content 706A-706N includes data objects or extensions to other data objects that are customized for one specific tenant 610A-610N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 706 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 702 and system content 704 and tenant content 706 of a specific tenant are accessed to provide the business process definition and/or the status information relating to a specific instance of the business process according to customizations and business data of that tenant such that each tenant is provided access to a customized solution whose data are available only to users from that tenant.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A computer program product comprising a machine-readable medium non-transitorily storing instructions that, when executed by at least one programmable processor, cause the at least one programmable processor to perform operations comprising:
accessing a definition of a business scenario, the definition comprising a designation of a plurality of business process features required for completion of the business scenario, one or more feature modules of an business software architecture providing functionality relating to one or more of the plurality of business process features, and an order in which the plurality of business process features are to be executed;
displaying, concurrently via a user interface presentable on a computer display device, a work frame and a navigation frame, the navigation frame comprising a first plurality of user interface elements arranged to represent at least some of the plurality of business process features, the work frame comprising a plurality of business configuration user interface elements relating to a selected one of the plurality of business process features, the business configuration user interface elements comprising organizational chart user interface elements;
receiving a user input via one or more of the plurality of business configuration user interface elements, the user input relating to a change to a business configuration for an organization using the business software architecture, the change comprising an assignment or reassignment of a role within the organization to the specific business process feature, the user input comprising making a linkage between one or more of the business configuration user interface elements relating to the role within the organization and one or more of the first plurality of user interface elements relating to the specific business process feature or another business process feature of the plurality of business process features; and
updating a business configuration model storing the business configuration to reflect the received change.

2. A computer program product as in claim 1, wherein the change further comprises an update to at least one of master data relating to the selected business process feature, and a functional detail relating to the selected business process feature.

3. A computer program product as in claim 2, wherein the update comprises at least one of an addition, a deletion, and a modification.

4. A computer program product as in claim 1, wherein the business configuration user interface elements further comprise at least one of master data entry fields, and functional detail user interface elements.

5. A computer program product as in claim 1, wherein the business configuration model and the business process definition are stored in at least one repository.

6. A computer program product as in claim 1, wherein the business configuration comprises organization-specific versions of the business scenario and at least one other business scenario.

7. A system comprising:
at least one programmable processor; and
a machine-readable medium storing instructions that, when executed by the at least one processor, cause the at least one programmable processor to perform operations comprising:
accessing a definition of a business scenario, the definition comprising a designation of a plurality of business process features required for completion of the business scenario, one or more feature modules of an business software architecture providing functionality relating to one or more of the plurality of business process features, and an order in which the plurality of business process features are to be executed;
displaying, concurrently via a user interface presentable on a computer display device, a work frame and a navigation frame, the navigation frame comprising a first plurality of user interface elements arranged to represent at least some of the plurality of business process features, the work frame comprising a plurality of business configuration user interface elements relating to a selected one of the plurality of business process features, the business configuration user interface elements comprising organizational chart user interface elements;
receiving a user input via one or more of the plurality of business configuration user interface elements, the user input relating to a change to a business configuration for an organization using the business software architecture, the change comprising an assignment or reassignment of a role within the organization to the specific business process feature, the user input comprising making a linkage between one or more of the business configuration user interface elements relating to the role within the organization and one or more of the first plurality of user interface elements relating to the specific business process feature or another business process feature of the plurality of business process features; and
updating a business configuration model storing the business configuration to reflect the received change.

8. A system as in claim 7, wherein the change further comprises an update to at least one of master data relating to the selected business process feature, and a functional detail relating to the selected business process feature.

9. A system as in claim 8, wherein the update comprises at least one of an addition, a deletion, and a modification.

10. A system as in claim 7, wherein the business configuration user interface elements further comprise at least one of master data entry fields, and functional detail user interface elements.

11. A system as in claim 7, wherein the business configuration model and the business process definition are stored in at least one repository.

12. A system as in claim 7, wherein the business configuration comprises organization-specific versions of the business scenario and at least one other business scenario.

13. A computer-implemented method comprising:
accessing a definition of a business scenario, the definition comprising a designation of a plurality of business process features required for completion of the business scenario, one or more feature modules of an business software architecture providing functionality relating to one or more of the plurality of business process features, and an order in which the plurality of business process features are to be executed;
displaying, concurrently via a user interface presentable on a computer display device, a work frame and a navigation frame, the navigation frame comprising a first plurality of user interface elements arranged to represent at least some of the plurality of business process features, the work frame comprising a plurality of business configuration user interface elements relating to a selected one of the plurality of business process features, the business configuration user interface elements comprising organizational chart user interface elements;
receiving a user input via one or more of the plurality of business configuration user interface elements, the user input relating to a change to a business configuration for an organization using the business software architecture, the change comprising an assignment or reassignment of a role within the organization to the specific business process feature, the user input comprising making a linkage between one or more of the business configuration user interface elements relating to the role within the organization and one or more of the first plurality of user interface elements relating to the specific business process feature or another business process feature of the plurality of business process features; and
updating a business configuration model storing the business configuration to reflect the received change;
wherein the accessing, the displaying, the receiving, and the updating are performed by at least one programmable processor.

14. A computer-implemented method as in claim 13, wherein the change further comprises an update to at least one of master data relating to the selected business process feature, and a functional detail relating to the selected business process feature.

15. A computer-implemented method as in claim 14, wherein the update comprises at least one of an addition, a deletion, and a modification.

16. A computer-implemented method as in claim 13, wherein the business configuration user interface elements further comprise at least one of master data entry fields, and functional detail user interface elements.

17. A computer-implemented method as in claim 13, wherein the business configuration comprises organization-specific versions of the business scenario and at least one other business scenario.

18. (canceled)

19. (canceled)

20. A computer program product as in claim 1, wherein the user input comprises at least one of a first drag-and-drop of the one or more of the business configuration user interface elements onto the one or more of the first plurality of user interface elements, and a second drag-and-drop of the one or more of the first plurality of user interface elements onto the one or more of the business configuration user interface elements.
